(19) United States
(12) Patent Application Publication
(10) Pub. No.: US 2005/0027678 A1
(43) Pub. Date: Feb. 3, 2005

(54) Computer executable dimension reduction and retrieval engine

(75) Inventors: Masaki Aono, Yokohama-shi (JP); Michael Edward Houle, Kawasaki-shi (JP); Mei Kobayashi, Yokohama-shi (JP)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 10/896,191

(22) Filed: Jul. 21, 2004

(30) Foreign Application Priority Data
Jul. 30, 2003 (JP) 2003-282690

(51) Int. Cl. G06F 7/00

(52) U.S. Cl. 707/1

(57) ABSTRACT

Provides a computer executable dimension reduction method, a program for causing a computer to execute the dimension reduction method, a dimension reduction device and a retrieval engine using the dimension reduction device. A dimension reduction device for reducing the dimension of a numerical matrix with a computer to provide a dimension reduction matrix and the information comprises a processing part for generating a dimension reduction matrix or the index data for dimension reduction using a random average matrix RAV to store the dimension reduction matrix or the index data. The processing part further comprises a shuffle vector generating part for generating a shuffle vector useful as the shuffle information, and a non-normalized basis vector generating part for generating the non-normalized basis vectors from the numerical elements of the data vector specified by the shuffle vector to store the non-normalized basis vectors.

### FIELD OF THE INVENTION

The present invention relates to information acquisition from a large scale database, and more particularly to a computer executable dimension reduction method, a program for causing a computer to perform the dimension reduction method, a dimension reduction device and an information retrieval engine using the dimension reduction device, in which the dimension reduction dependent upon the document data stored in a database is enabled with the power saving of computer hardware.

### BACKGROUND

Along with the remarkable development of computer environments in recent years, the techniques for finding necessary knowledge information from the large scale database via the Internet or Intranet, including so-called information retrieval, clustering, and data mining have become more important. When a corpus of large scale document data is given, a method for providing the information retrieval or clustering (document classification) efficiently and precisely makes a great contribution to the knowledge retrieval technique in the database in which data is increasingly accumulated along with the expansion of network.

The following Non-patent documents are considered:

[Non-Patent Document 1]

Kenji Kita, Kazuhiko Tsuda, Masamiki Shishibori, Information retrieval algorithm, Kyoritsu Shuppan, 2002

[Non-Patent Document 2]

Richard K. Below, Findings Out About, Cambridge University Press, Cambridge, UK, 2000

[Non-Patent Document 3]

G. Salton and M. Mcgill, Introduction to Modern Information Retrieval, McGraw-Hill, 1983

[Non-Patent Document 4]

Scott Deerwester, et al., “Indexing by Latent Semantic Analysis”, Journal of the American Society for Information Science, Vol. 41, (6), 391-407, 1990

[Non-Patent Document 5]

Masaki Aono, Mei Kobayashi, “Retrieval and Visualization of Large Scale Document Data by Dimension Reduction based on Vector Space Model”, Information Processing Society of Japan, Multimedia and Distributed Processing Research Meeting, 2002-DPS-108, pp. 79-84, June, 2002

[Non-Patent Document 6]

Minoru Sasaki, Kenji Kita, “Dimension Reduction of Vector Space Information Retrieval Model with Random Projection”, Natural Language Processing, Vol. 8, No. 1, pp. 5-19, 2001

[Non-Patent Document 7]

Mei Kobayashi, Masaki Aono, “Covariance matrix analysis for mining major and minor clusters”, 5-th International Congress on Industrial and Applied Mathematics (ICIAM), Sydney, Australia, pp. 188, July 2003

[Non-Patent Document 8]

K. V. Mardia, J. T. Kent and J. M. Bibby, Multivariate Analysis, Academic Press, London, 1979

[Non-Patent Document 9]

Dimitris Achilioptas, “Database-friendly Random Projections”, In Proc. ACM Symposium on the Principles of Database Systems, pp. 274-281, 2001

[Non-Patent Document 10]

Ella Bingham and Heikki Mannila, “Random projections in dimensionality reduction: Applications to image and text data”, Proc. ACM SIG KDD, pp. 245-250, San Francisco, Calif., USA, 2001

Firstly, for the information retrieval, various models have been proposed. For example, an information retrieval of a so-called Query-by-Terms method is supposed. Also, in a case of retrieving a document having a representation fully coincident with a query, a full text retrieval model may be suitable (non-patent document 1). On the other hand, when the information retrieval is similar retrieval or conceptual retrieval, a so-called Query-by-Example is supposed. If the same model is applied to clustering at the same time, a content retrieval model is effectively employed. A vector space model is effective as the analytical model that is commonly employed for any information retrieval (non-patent document 2). The conventional techniques referred to or employed in this invention will be outlined below.

(1) Vector Space Model

In a vector space model (VSM), each document contained in a document corpus is modeled by a vector of a set of keywords. As the method for weighting the keyword that is applied in modeling, a simple Boolean method for representing by only one bit whether or not a keyword is contained, and a TF-IDF method based on the appearance frequency of keyword in a document or whole document are well known (non-patent document 2). In the VSM, the document corpus is represented as an M×N numerical matrix, or a so-called document keyword matrix, where the number of documents is M and the number of keywords is N (non-patent document 3).

(2) Dimension Reduction Technique

To enhance the retrieval efficiency, it is common practice that the dimension of keyword vector is reduced to a much smaller dimension k than N in the M×N numerical matrix (hereinafter referred to as A) of the document corpus. For this purpose, there are a Latent Semantic Indexing (LSI) method as proposed by Deerwester et al. (non-patent document 4) and a Covariance Matrix (COV) Method as proposed by the present inventors (non-patent document 5, non-patent document 1, non-patent document 6, non-patent document 7, non-patent document 8).

With the LSI method, a given, normally rectangular matrix A is decomposed into singular values, and k singular vectors are selected in the order in which the singular value is larger to reduce the dimension. Also, with the COV method, a covariance matrix C is generated from the matrix A. The covariance matrix C is provided as an N×N symmetric matrix, and calculated easily at high precision, using an eigenvalue decomposition. In this case, the dimension reduction is performed by selecting k eigenvectors in the order of larger value. The COV method has a feature that highly correlated data is relatively easy to form a cluster, because the covariance matrix C itself already reflects the correlation between keywords to some extent.

Besides, another method for reducing the dimension of a huge numerical matrix is a Random Production (hereinafter referred to as RP) method. The RP method (non-patent document 9, non-patent document 10) is primarily employed in the fields of LSI design and noise removal of image, in which an N×k dimensional random matrix R is firstly generated, and multiplied by the matrix A to make the dimension reduction. In this case, it is unnecessary to perform the singular value decomposition or eigenvalue decomposition for a huge numerical matrix, so that the dimension reduction calculation is necessarily made faster, and the capacity of computer hardware resources smaller. However, the RP method has a problem that the cluster distribution within the document is not reflected, because the random matrix R is generated regardless of data accumulated within the database. That is, there is a very high possibility that the dimension reduction matrix A may not reflect the cluster size.

In most cases, even when the retrieval engine is not highly dedicated, the major cluster can be retrieved. In addition, the person making the information retrieval is often interested in the cluster of data having a small existence percentage of non-major cluster (hereinafter referred to as a minor cluster). In this regard, the RP method had an inconvenience that though it allows the calculation at high speed and in resource saving, the generated dimension reduction data has reduced dimension without referring to the document data, and the cluster distribution information within the document is discarded, it being not assured that the major cluster and the minor cluster are detected in accordance with the distribution. Therefore, the RP method could be used to make the keyword retrieval, but did not provide enough information to make the semantic analysis or the information retrieval represented by similar retrieval.

Up to now, an information acquisition method satisfying the precision, high speed and resource saving at the same time, a dimension reduction device, a retrieval engine comprising a dimension reduction device, and a computer program have not been provided, whereby it is necessary to have an information acquisition method satisfying the precision, high speed and resource saving at the same time, a retrieval engine, and a computer program.

### SUMMARY OF THE INVENTION

Therefore, it is an aspect of this invention to provide information acquisition methods, apparatus and systems satisfying the precision, high speed and resource saving at the same time, and a retrieval engine.

In an example embodiment of this invention, an M×N numerical matrix is generated from data stored in the database, and M data vectors are shuffled randomly. Thereafter, for M data vectors, k chunks having a roughly equal number of vectors are provided. A non-normalized basis vector is calculated from the vectors included in one chunk, whereby k non-normalized basis vectors are generated corresponding to the number of chunks k. For a document keyword numerical matrix A in which the number of documents is M and the total number of keywords is N, k non-normalized basis vectors generated by averaging the document vectors within the chunk are made orthogonal to provide a k×N dimensional random average (RAV) matrix. For this random average matrix RAV, a transposed matrix ^{t}RAV of N×k dimensions is multiplied by the numerical matrix A to generate a dimension reduction matrix A′ of M×k dimensions in which the keyword dimension is reduced. A retrieval engine of the invention involves calculating a query vector from a retrieval query input by the user, and calculating an inner product with the generated dimension reduction matrix A′. Since the inner product value corresponds to the degree of similarity between the query vector and the document, sorted in order of size, and stored as the retrieval result with a ranking value such as top 10 or top 100 in the computer apparatus.

In another aspect of this invention, the random average matrix RAV is generated based on the data vector stored in the database without performing the eigenvalue computer or singular value computation for the large scale numerical matrix. Therefore, the computational efficiency is greatly improved in terms of the computation speed and the capability and memory capacity of the processing apparatus. In addition, the random average matrix RAV is computed based on the data of document stored in the database, and applicable to the automatic classification of documents within the database, similar retrieval and clustering computation.

That is, the invention provides a dimension reduction method for reducing the dimension of a numerical matrix with a computer to provide the information, comprising:
a step of generating the shuffle information by selecting randomly a data vector stored in a database and storing the shuffle information in a memory; and
a step of reducing the dimension of the numerical matrix by the basis vectors that are made orthogonal using the shuffle information.

Another aspect of this invention, provides a computer executable program for performing a dimension reduction method for reducing the dimension of a numerical matrix with a computer to provide a dimension reduction matrix or the index data for dimension reduction

Another aspect of this invention, provides a dimension reduction device for reducing the dimension of a numerical matrix with a computer to provide a dimension reduction matrix or the index data for dimension reduction

Another aspect of this invention, provides a retrieval engine for enabling a computer to provide the information.

### BRIEF DESCRIPTION OF THE DRAWINGS

The above and other objects, features, and advantages of the present invention will become more apparent from the following detailed description when taken in conjunction with the accompanying drawings, in which:

FIG. 1 is a schematic view showing a process for generating a document keyword matrix from a document stored in a database according to the present invention;

FIG. 2 is a schematic view showing a method for shuffling randomly a data vector according to the invention;

FIG. 3 is a flowchart of an essential process for generating a random average matrix according to a suitable embodiment of the invention;

FIG. 4 is a diagram showing a specific process as shown in FIG. 3 through an arithmetical operation for vector elements;

FIG. 5 is a schematic view showing the degree of contribution of major cluster and minor cluster to the basis vectors generated in the invention and the degree of contribution of major cluster and minor cluster to the basis vectors given by the RP method;

FIG. 6 is a flowchart showing a process of a retrieval engine using a retrieval engine structure of the invention;

FIG. 7 is a schematic view showing the configuration of a retrieval engine using an RAV method of the invention;

FIG. 8 is a block diagram showing a hardware configuration of a computer apparatus usable in the retrieval engine of the invention;

FIG. 9 is a block diagram showing the functions for performing the RAV method that are configured as software or hardware in the computer apparatus 12 and the functions for external control made by the computer apparatus 12; and

FIG. 10 is a graphical representation showing the typical results obtained by the RAV method and RP method.

### DESCRIPTION OF SYMBOLS

10 . . . Retrieval engine
12 . . . Computer apparatus
14 . . . Database
16 . . . Input/output unit
18 . . . Display unit
20 . . . Memory
22 . . . Central processing unit
24 . . . Input/output control unit
26 . . . Network
28 . . . External communication device
32 . . . RAV processing part
34 . . . Random average matrix storing part
36 . . . Dimension reduction data storing part
38 . . . Inner product calculating part
40 . . . Query vector storing part
42 . . . Retrieval result storing part
44 . . . Shuffle vector generating part
46 . . . Non-normalized basis vector generating part
48 . . . Orthogonal processing part

### DETAILED DESCRIPTION OF THE INVENTION

The present invention provides methods, systems and apparatus for dimension reduction for reducing the dimension of a numerical matrix with a computer to provide the information.

It provides for information acquisition from a large scale database. Included are a computer executable dimension reduction method, a program for causing a computer to perform the dimension reduction method, a dimension reduction device and an information retrieval engine using the dimension reduction device, in which the dimension reduction dependent upon the document data stored in a database is enabled with the power saving of computer hardware.

This invention has been achieved in the light of the above-mentioned problems associated with the conventional technique. It has been noted that the basis vectors useful for dimension reduction of k dimensions can be created randomly without depending on the size of data accumulated in the database. Thus, the present inventors have completed this invention on the basis of an idea that the reliable knowledge acquisition is enabled by making the retrieval precision of information of major and minor clusters at high speed and high efficiency, if it is possible to randomize the data vector while a cluster distribution latent inside the data is held from data accumulated in a large scale database.

More specifically, in this invention, an M×N numerical matrix is generated from data stored in the database, and M data vectors are shuffled randomly. Thereafter, for M data vectors, k chunks having a roughly equal number of vectors are provided. A non-normalized basis vector is calculated from the vectors included in one chunk, whereby k non-normalized basis vectors are generated corresponding to the number of chunks k.

For a document keyword numerical matrix A in which the number of documents is M and the total number of keywords is N, k non-normalized basis vectors generated by averaging the document vectors within the chunk are made orthogonal to provide a k×N dimensional random average (RAV) matrix. For this random average matrix RAV, a transposed matrix ^{t}RAV of N×k dimensions is multiplied by the numerical matrix A to generate a dimension reduction matrix A′ of M×k dimensions in which the keyword dimension is reduced. A retrieval engine of the invention involves calculating a query vector from a retrieval query input by the user, and calculating an inner product with the generated dimension reduction matrix A′. Since the inner product value corresponds to the degree of similarity between the query vector and the document, sorted in order of size, and stored as the retrieval result with a ranking value such as top 10 or top 100 in the computer apparatus.

In this invention, the random average matrix RAV is generated based on the data vector stored in the database without performing the eigenvalue computer or singular value computation for the large scale numerical matrix. Therefore, the computational efficiency is greatly improved in terms of the computation speed and the capability and memory capacity of the processing apparatus. In addition, the random average matrix RAV is computed based on the data of document stored in the database, and applicable to the automatic classification of documents within the database, similar retrieval and clustering computation.

That is, the invention provides a dimension reduction method for reducing the dimension of a numerical matrix with a computer to provide the information, comprising: a step of generating the shuffle information by selecting randomly a data vector stored in a database and storing the shuffle information in a memory; and a step of reducing the dimension of the numerical matrix by the basis vectors that are made orthogonal using the shuffle information.

In the invention, the step of generating the shuffle information comprises a step of storing an identification value of the data vector selected randomly in a memory in the selected order and a step of generating a shuffle vector, and the step of reducing the dimension comprises a step of reading the numerical elements of the data vector specified by the shuffle vector from the database, and calculating an average value for every allocated chunk to generate the non-normalized basis vectors that are stored in a memory, a step of making the non-normalized basis vectors orthogonal to generate the normalized basis vectors that are stored as a random average matrix in a memory, and a step of multiplying the random average matrix by the data vector to generate a dimension reduction matrix with reduced dimension or the index data for dimension reduction that is stored in a storing part. Also, in the invention, the number of the chunks corresponds to the number of basis vectors. Also, in the invention, the step of calculating the average value comprises a step of averaging the elements of the data vector for every floor (M/k) with the number of data vectors (M) and the number of basis vectors (k).

Also, this invention provides a computer executable program for performing a dimension reduction method for reducing the dimension of a numerical matrix with a computer to provide a dimension reduction matrix or the index data for dimension reduction, the method comprising: a step of generating the shuffle information by selecting randomly a data vector stored in a database and storing the shuffle information in a memory; and a step of reducing the dimension of the numerical matrix by the basis vectors that are made orthogonal using the shuffle information.

Also, the invention provides a dimension reduction device for reducing the dimension of a numerical matrix with a computer to provide a dimension reduction matrix or the index data for dimension reduction, the device comprising: a processing part for generating the shuffle information by selecting randomly a data vector stored in a database to store the shuffle information in a memory; and a processing part for generating a random average matrix with the basis vectors that are made orthogonal using the shuffle information, and generating a dimension reduction matrix or the index data for dimension reduction using the random average matrix to store the dimension reduction matrix or the index data.

In the dimension reduction device of the invention, the processing parts comprise a shuffle vector generating part for generating the shuffle information as a shuffle vector by storing an identification value of the data vector selected randomly in a memory in the selected order and a non-normalized basis vector generating part for generating the non-normalized basis vectors that are stored in a memory by reading the numerical elements of the data vector specified by the shuffle vector from the database, and calculating an average value for every allocated chunk.

In the dimension reduction device of the invention, the processing parts comprise a random average matrix generating part for generating a random average matrix with the normalized basis vectors obtained by making the non-normalized basis vectors orthogonal, and a dimension reduction data storing part for generating a dimension reduction matrix with reduced dimension or the index data for dimension reduction that is stored in a storing part by reading the random average matrix, and multiplying the random average matrix by the data vector.

Also, the invention provides a retrieval engine for enabling a computer to provide the information, comprising: a processing part for generating the shuffle information by selecting randomly a data vector stored in a database to store the shuffle information in a memory; a processing part for generating a random average matrix with the basis vectors that are made orthogonal using the shuffle information, and generating a dimension reduction matrix using the random average matrix to store the dimension reduction matrix; a query vector storing part for generating and storing a query vector; an inner product calculating part for calculating an inner product between the dimension reduction matrix and the query vector; and a retrieval result storing part for storing a score of the calculated inner product.

In the retrieval engine of the invention, the processing parts comprise a shuffle vector generating part for generating the shuffle information as a shuffle vector by storing an identification value of the data vector selected randomly in a memory in the selected order and a non-normalized basis vector generating part for generating the non-normalized basis vectors that are stored in a memory by reading the numerical elements of the data vector specified by the shuffle vector from the database, and calculating an average value for every allocated chunk.

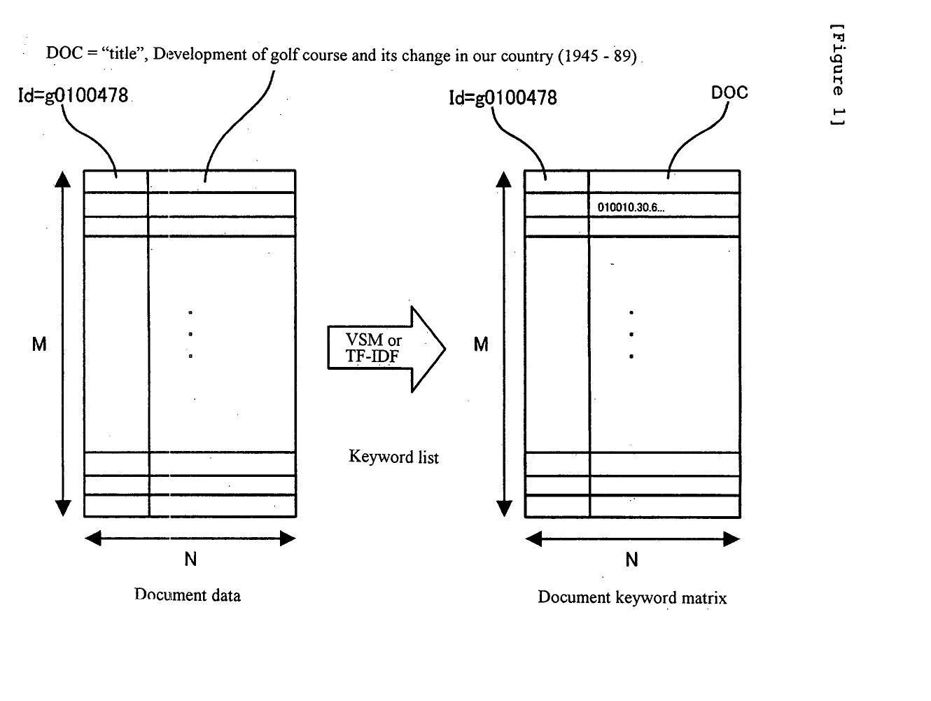

In the retrieval engine of the invention, the processing parts comprise a random average matrix generating part for generating a random average matrix with the normalized basis vectors obtained by making the non-normalized basis vectors orthogonal, and a dimension reduction data storing part for generating a dimension reduction matrix with reduced dimension or the index data for dimension reduction that is stored in a storing part by reading the random average matrix, and multiplying the random average matrix by the data vector. In an advantageous embodiment of the invention, the data vector comprises a number vector in which a document is digitized using a keyword. Advantageous embodiments of the present invention will be described below with reference to the accompanying drawings, but the invention is not be limited to the embodiments as shown in the drawings. FIG. 1 is a schematic view showing a process for generating a document keyword matrix from a document stored in a database according to the present invention. FIG. 1A shows the configuration of a document database and FIG. 1B shows the configuration of the document keyword matrix. As shown in FIG. 1, the document data “DOC” of the database, for example, has a document reference number, or an identification value intrinsic to the database, with which the document data can be properly called. Also, the document data as shown in FIG. 1A has usually a header or a title, in which these keywords are digitized by the VSM or TF-IDF method with reference to a keyword list.

Consequently, a number vector composed of an element having the title or header digitized is generated for the document data, as shown in FIG. 1B. In the following, this vector is referred to as a data vector. This invention is applicable not only to the document data, but also to any data including the text. The data vectors are stored as a document keyword matrix in an appropriate area of the database or another database. In the document keyword matrix as shown in FIG. 1, the number of data vectors is equal to the number of document data M, and the number of keywords is N.

The data vector has an identification value “Id” that is the same as that of the corresponding document data, or related with it for reference, as shown in FIG. 1A. The document keyword matrix of FIG. 1B has the same identification value in the described embodiment. This identification value “Id” is attached in the sequence of time series in which the document data is registered or generated in the database in most cases such as the news items or leading article. Therefore, between the identification value and the keyword included in the data vector, there is the possibility that the data vectors are concentrated in a particular columnar area of the document keyword matrix, for example, in a predetermined district or at a date and time in the case of earthquake or weather.

In this invention, in this case, a specific basis vector depends on a storage or generation history of data. Thus, in this invention, the data vectors making up the document keyword matrix as shown in FIG. 1 are shuffled randomly in a column direction to create the shuffle information, which is stored in storage means such as database or memory for later reference. Using the shuffle information, the history in the database has less influence on the calculation of basis vectors, and the major cluster, medium cluster, and minor cluster latently included in each basis vector are distributed roughly uniformly. That is, the dimension reduction method becomes faithful to the distribution of clusters.

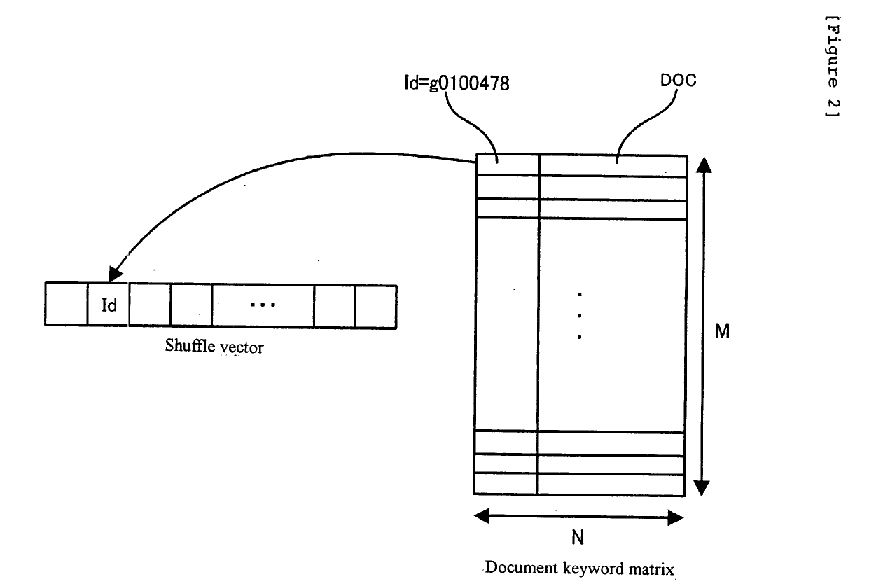

FIG. 2 schematically shows a method for shuffling randomly the data vector according to a suitable embodiment of the invention. In this invention, the method for shuffling randomly the data vector is used to generate the matrix positively by rearranging the data vectors randomly, or generate a shuffle vector in which the identification values of the document or the data identification values in the database are arranged randomly. In this invention, the shuffle information means the information of the matrix data consisting of the data vectors rearranged randomly, or reference information for referring to the data vectors in which the data vectors are rearranged randomly. In this invention, though the use of the shuffle information containing M×N elements of the document keyword matrix is not excluded, it is desirable to employ the shuffle vector that is generated only by securing a memory address corresponding to the number of data vectors M, as shown in FIG. 2, in consideration of the hardware resource saving and the computational efficiency in a more suitable embodiment of the invention. Though various shuffle methods may be employed, for example, M one-dimensional arrays B are prepared, and initialized such as B[i]=i (1≦i≦M), with the identification value “Id” of data vector corresponding to the integer 1, . . . , M. And one integer is selected randomly from the interval [1, M] and set as S, whereby B[M] and B[S] are exchanged. Then, one integer is selected randomly from the interval [1, M-1], and set as S again, whereby B[M-l] and B[S] are exchanged. The same processing is repeated up to B[l] while the interval is narrowed, so that a random integer array B is produced. This random integer array is employed as the shuffle vector.

In the computation process, when the shuffle vector is referenced, the shuffle vector is sequentially read from the top or end, in which the corresponding data vector is referred to, and the elements of the corresponding data vector are averaged. Also, in this invention, a chunk is set for every predetermined number of elements of the shuffle vector, and the reference of the shuffle vector is made for every number of data vectors assigned to the chunk. The number of chunks corresponds to the number of basis vectors k in this invention.

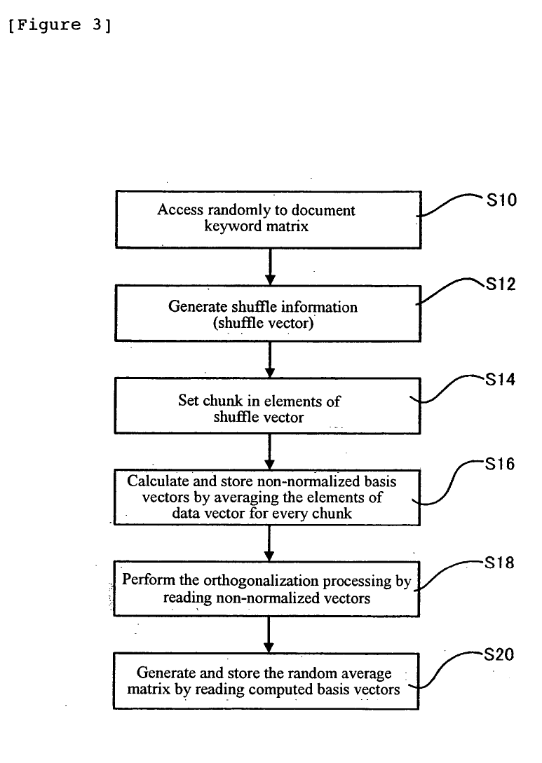

FIG. 3 is a flowchart showing an essential process for generating a random average matrix RAV according to a suitable embodiment of the invention. In this process for generating the random average matrix of the invention as shown in FIG. 3, at step S10, the document keyword matrix is accessed to acquire the identification value of the data vector randomly. At step S12, the read identification values are stored in a memory formed by an appropriate storage device such as RAM, and held as the shuffle vector. At step S14, the chunk is defined, for example, as floor (M/k) for the number of data M in the shuffle vector, and assigned to a desired number of basis vectors. In this case, it is preferable that the number of each chunk is roughly equal to make the weight of each basis vector uniform, but the coincidence between the number of data included in each chunk and the number of each chunk is not specifically limited in this invention.

At step S16, the elements of the data vector are read for every chunk, and integrated in an appropriate memory to calculate an average value. This processing is repeated by the number of keywords N, whereby the non-normalized basis vectors di (1≦i≦k) are calculated for every chunk, and stored in memory. At step S18, the stored non-normalized basis vectors di are read, and made orthogonal, whereby the basis vectors b₁, b₂, b₃, . . . , bₖ are calculated and stored in an appropriate memory.

Moreover, at step S20, the calculated basis vectors bᵢ are read, arranged sequentially in an appropriate memory, and stored as the k×N dimensional random average matrix RAV. The RAV is produced through the process for referring to and averaging the data vectors for every chunk in this way. Statistically, the RAV is reflected in the basis vectors having the ratio of major cluster to minor cluster at the almost same ratio as included in the original document keyword matrix.

Therefore, when the dimension reduction is made in this invention, the detectability from major cluster to minor cluster is not appreciably decreased. Also, the orthogonal processing at step S18 is sequentially performed by using a modified Gram Schmidt (MGS) method, for example.

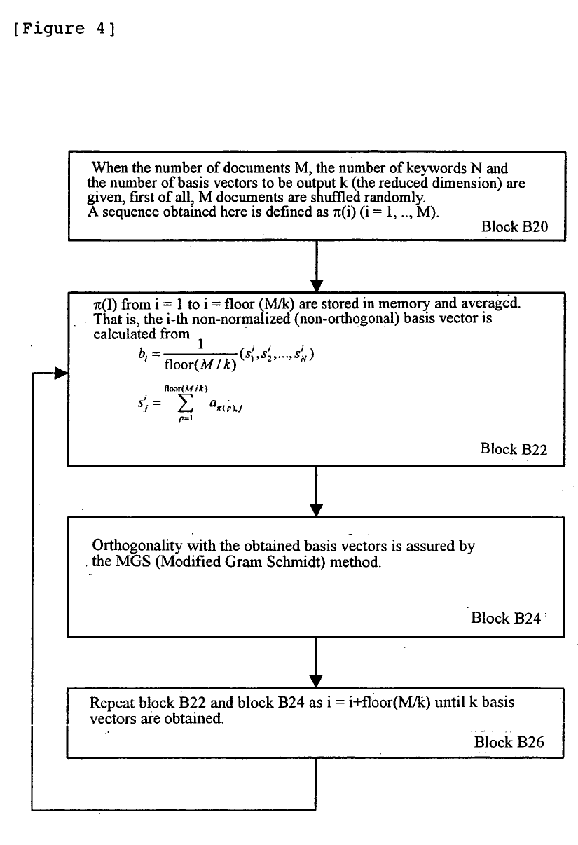

FIG. 4 is a diagram showing a specific process as shown in FIG. 3 using an arithmetical operation for vector elements. In FIG. 4, floor (M/k) denotes the number of vectors included in the chunk, and “floor( )” denotes an operator for truncating the decimal place of the value in parentheses. sⁱⱼ (1≦i≦k, 1≦j≦N) denotes the sum of j-th elements of the vectors included within the chunk. In block B20 as shown in FIG. 4, the data matrix is read, the shuffle vector is generated by random number generating means, and the data vector specified by that sequence is represented as π(p) (1≦p≦M).

In block B22, the chunk is assigned to given shuffle vectors for every floor (M/k), whereby the average value of j-th elements of the data vectors is calculated. aπ(p),j in block B22 of FIG. 4 denotes the j-th element of the π(p)-th data vector. At the time when the average of elements is completed in block B22, the non-normalized basis vectors are generated. These non-normalized basis vectors di are stored in an appropriate memory.

With the MGS method in block B24, the number of calculated non-normalized basis vectors is counted at the first stage until at least three non-normalized basis vectors are accumulated in the specific embodiment. In Block B24, at the time when a predetermined number of non-normalized basis vectors are accumulated, the non-normalized basis vectors dᵢ are made orthogonal by applying the MGS method, whereby the normalized basis vectors are calculated and stored in memory. Thereafter, in block B26, the processing chunk is incremented such as i=i+floor(M/k), in which the calculation of the non-normalized basis vectors in block B22 and the sequential orthogonal processing in block B24 are performed again. Finally, the k normalized basis vectors are generated corresponding to all the chunks. Then, the procedure is ended.

The number of chunks k may be automatically set corresponding to the number of data by the system, or set by the user who inputs the number of basis vectors into the system, and appropriately selected in accordance with a user's preference or the apparatus environment.

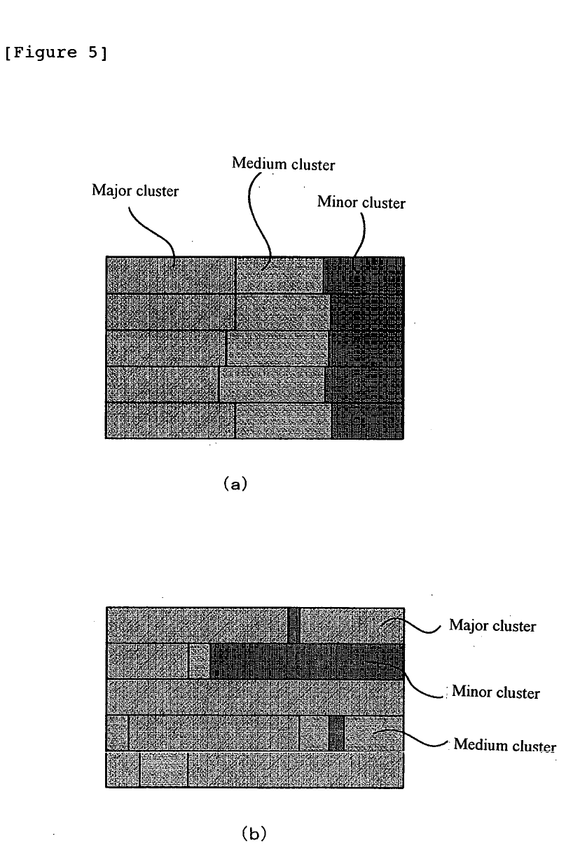

FIG. 5 is a schematic view showing the degree of contribution of major cluster and minor cluster to the basis vectors generated in the invention and the degree of contribution of major cluster and minor cluster to the basis vectors given by the RP method. FIG. 5A shows the degree of contribution of major cluster and minor cluster to basis vectors generated by the RAV method of the invention and FIG. 5B shows the degree of contribution of major cluster and minor cluster to the basis vectors given by the RP method. As shown in FIG. 5A, statistically, the basis vectors of the invention contain the elements from the major cluster to the minor cluster at the almost same percentage as latently included in the original data vectors.

With the RAV method of the invention, data from the major cluster to the minor cluster are employed without exception to determine the basis vectors. Therefore, it is statistically assured that any basis vector contains the element of each cluster, whereby the dimension reduction matrix applicable to the data mining or similar retrieval or the index data for dimension reduction is provided, irrespective of high speed dimension reduction. In this invention, the index data means the set of identification values, which are required to make the dimension reduction and appropriately call the data vector in the corresponding RAV process, or means the data for generating the data vectors of reduced dimension on the fly when an inner product calculating process is called using the index data.

On the other hand, with the RP method as shown in FIG. 5B, the basis vectors are generated essentially without depending on the data vectors. Especially at the time of actual implementation, there is the possibility of generating the data vector in which the minor cluster is exaggerated and the major cluster is buried, or conversely the data vector in which the major cluster is only contained. Therefore, the keyword retrieval has a low precision and is not applied to the practical data mining or similar retrieval.

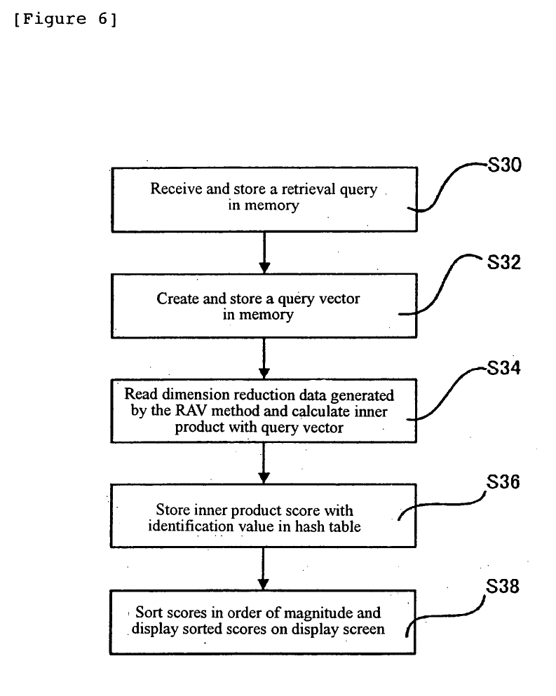

FIG. 6 is a flowchart showing a process of a retrieval engine using a retrieval engine structure of the invention. The retrieval engine of the invention receives a retrieval query and stores it in an appropriate buffer memory at step S30. The retrieval query may be input from the keyboard by the user, or a web service protocol request represented by an HTTP request containing the retrieval query data transmitted via the network in another embodiment of the invention. Thereafter, at step S32, the input retrieval query is digitized using a keyword list stored in the retrieval engine, and stored in an appropriate buffer memory.

At step S34, the dimension reduced data that is referred to as the data vector of reduced dimension included in the dimension reduction matrix generated by the RAV method of the invention, or the index data, read into the buffer memory to calculate the inner product with the retrieval query. At step S36, the generated score is stored in a hash table created in an appropriate memory, corresponding to the identification value of data vector. At step S38, the results are sorted in the order in which the score is larger, and the retrieval result is displayed on the display screen. The retrieval result is displayed in various ways, but may be graphically displayed using a graphical user interface, or displayed on the screen as a hyper text markup language (HTML) or extended markup language (XML) in which the retrieved data vector is hyper linked using the identification value, for example.

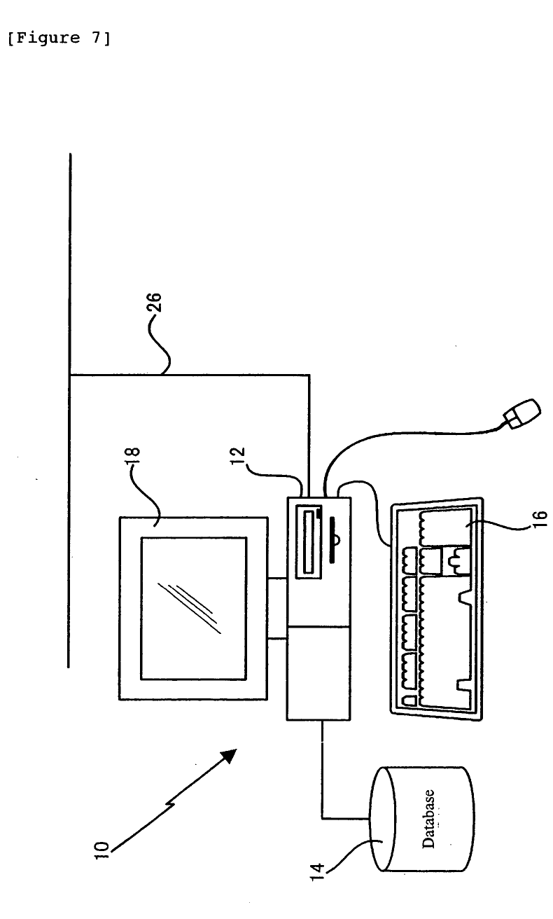

FIG. 7 is a schematic view showing the configuration of the retrieval engine using the RAV method of the invention. The retrieval engine 10 as shown in FIG. 7 roughly comprises a computer apparatus 12, a database 14 managed by the computer apparatus 12, an input/output unit 16 allowing the user to input or output data into or from the computer apparatus 12, and a display unit 18 having the display screen. Upon receiving a retrieval query from the user, the retrieval engine 10 reads the data vector from the dimension reduction matrix stored in an appropriate storage area of the retrieval engine 10, or reads the index data for dimension reduction to perform the retrieval, the result being displayed on the display screen using the numerical data or the graphical user interface. In this invention, the retrieval engine 10 may be configured as a cgi system or web software, in which the retrieval query is transmitted via a network 26 from the user computer located remotely.

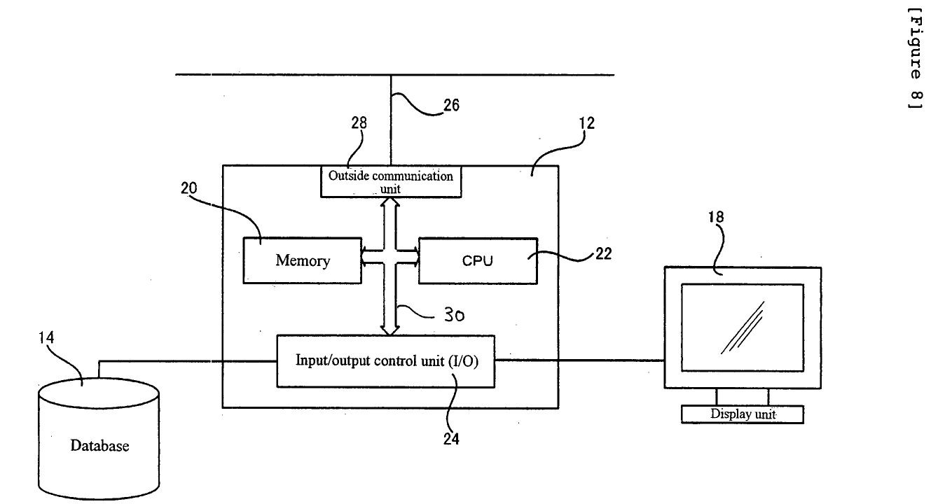

FIG. 8 is a block diagram showing a hardware configuration of the computer apparatus 12 usable in the retrieval engine of the invention. The computer apparatus 12 roughly comprises a memory 20, a Central Processing Unit (CPU) 22, an input/output control unit 24, and an outside communication unit 28 for processing a retrieval request from the network 26 when the retrieval service is provided via the network. The memory 20, the Central Processing Unit 22, the input/output control unit 24, and the outside communication unit 28 are interconnected via an internal bus 30 to enable the data transmission. Also, the computer apparatus 12 may be implemented as a stand alone system, or as a server for providing the retrieval service that is connected via the network 26 such as the Internet in another embodiment.

In the case where the computer apparatus 12 is employed as the stand alone retrieval engine, the user inputs the retrieval query via a predetermined graphical user interface (GUI) using the input/output unit 16 such as keyboard or mouse. Upon receiving the retrieval query, the computer apparatus 12 generates the query vector from the retrieval query, calculates the inner product between the data vector and the dimension reduction matrix, and performs the retrieval.

Also, in the case where the computer apparatus 12 is provided as the server, the computer apparatus 12 receives an HTTP request for retrieval via the network 26 and saves it in the buffer memory in the outside communication unit 28. Thereafter, a retrieval application program is initiated or called, and subsequently, the query vector is generated from the retrieval query transmitted from the user. Furthermore, the retrieval result is produced by performing the process as shown in FIG. 6, using the query vector, and stored in the memory 20. The stored retrieval result is returned as an HTTP response to the user via the network by the outside communication unit 28.

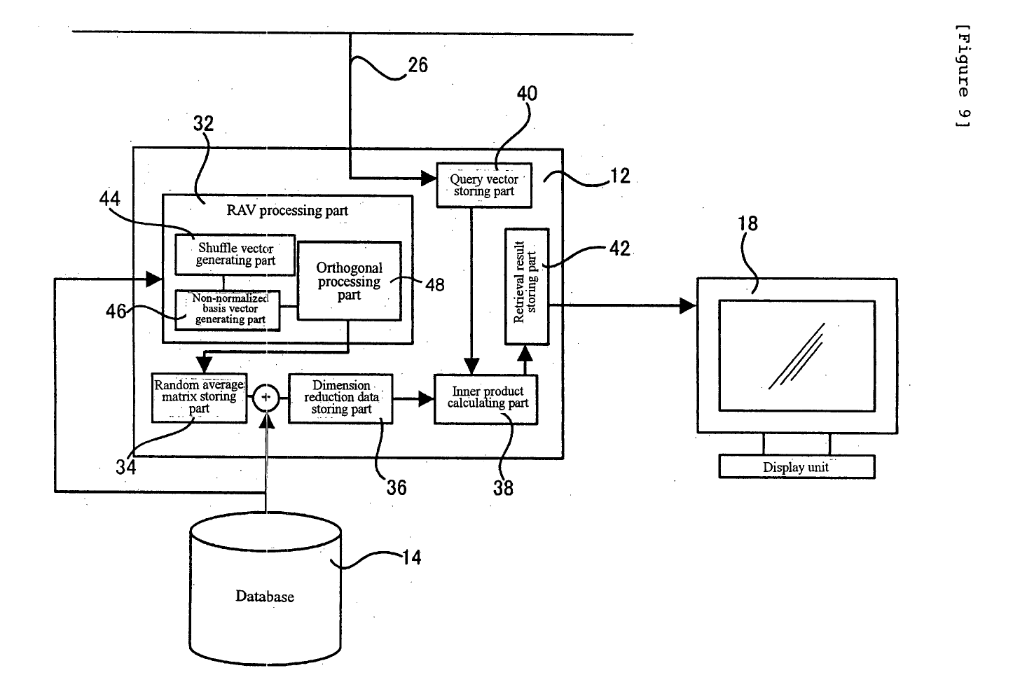

FIG. 9 is a block diagram showing the functions for performing the RAV method that are configured as software or hardware in the computer apparatus 12 and the functions for external control made by the computer apparatus 12. As shown in FIG. 9, the computer apparatus 12 comprises an RAV processing part 32, a random average matrix storing part 34, a dimension reduction data storing part 36, an inner product calculating part 38, a query vector storing part 40, and a retrieval result storing part 42, which are functionally configured or connected.

The function of the RAV processing part 32 will be described below. The RAV processing part 32 generates the shuffle vector as the shuffle information associated with the data in the database, not shown, and calculates the basis vectors according to the invention. The calculated basis vectors are sent to the random average matrix storing part 34 and stored in a predetermined format for the random average matrix RAM. Moreover, a dimension reduction matrix ARAV is calculated by multiplying the random average matrix RAV and the document keyword matrix. This ARAV matrix is stored in a dimension reduction data storing part 36, which is configured as the storage unit such as hard disk, to calculate the inner product for the retrieval query.

Also, in this invention, the dimension reduction matrix ARAV may not be positively created, but stored in the dimension reduction data storing part 36 as the dimension reduction data in which the identification value of document keyword matrix as the index data and the identification value of a predetermined column vector in the random average matrix RAV corresponding to the basis vectors are paired. On the other hand, the query vector stored in the query vector storing part 40, or the data vector having dimension reduced in the dimension reduction data storing part 36, or the index data is read into the inner product calculating part 38 to perform the inner product, and the calculated inner product score is stored in the retrieval result storing part 42. When the index data is employed, the inner product calculating part 38 creates the data vector of reduced dimension directly from the index data on the fly, which is used to calculate the inner product. Also, in this invention, a dimension reduced vector generating part is provided in a functional portion on the input side of the inner product calculating part 38 and on the downstream side of the dimension reduction data storing part and the generated dimension reduced vector is input into the inner product calculating part 38 in FIG. 9. Also, the functional blocks of the RAV processing part 32 of the invention are illustrated together in FIG. 9. As shown in FIG. 9, the RAV processing part 32 comprises a shuffle vector generating part 44, a non-normalized basis vector generating part 46, and an orthogonal processing part 48. The shuffle vector generating part 44 reads the data vector or the identification value of the data vector from the database 14, and generates the shuffle vector as the shuffle information for arranging the data vector randomly, the shuffle vector being stored in an appropriate memory such as buffer memory. The non-normalized basis vector generating part 46 calculates the non-normalized basis vector by referring to the shuffle vector and averaging the numerical elements of the data vector for each chunk, and stores the calculated non-normalized basis vector in memory. The orthogonal processing part 48 reads the non-normalized basis vector stored in memory and performs the orthogonal processing using the MGS method in the specific embodiment of the invention, the generated normalized basis vectors b₁, b₂, b₃, . . . , bk being stored as the matrix (array data) in appropriate format in the random average matrix storing part 34. Thereafter, the dimension reduction matrix is calculated, the inner product with the query vector is computed, and the retrieval result is stored and displayed in appropriate format to the user, as described above.

The functional blocks of the invention may be configured as a software block in a computer executable program read and executed by the computer. The computer executable program is described in various languages, including C, C++, FORTRAN, and JAVA®.

### EXAMPLES

Specific examples of the invention will be described below in detail.

### Example 1

Comparative Examination With the Conventional Method

(1) Database Used in the Experiment

The database data had a size of 332,918 documents, and 56,300 keywords, in which the dimension reduction was made to 300 dimensions.

(2) Hardware Environment Used in the Experiment

The computer apparatus was IntelliStation (manufactured by IBM) with the CPU of Pentinum 4, 1.7 GHz, and the operating system of Windows® XP.

(3) Computation Time

The computation time was compared between the RAV method and the COV method under the above-mentioned conditions. The results are shown in Table 1.

TABLE 1

| | RAV | COV |
|---|---|---|
| Computation time | 15 min. | 8 hrs. |

As seen from Table 1, the RAV method of the invention was about 30 times faster than the COV method. Also, the scalability of computation time was only proportional to M in the RAV method, but was roughly proportional to the number of keywords (N) to the third power in the COV method. That is, it was revealed that the RAV method was more excellent in the scalability of computation time than the conventional dimension reduction method.
(4) Precision

The precision of the RAV method of the invention was examined using a measure whether or not the top 10 or top 20 documents among the retrieved documents contain a quite small number of query keywords with df=49 or 29. As a result, for the keywords with df=49, the precision (precision value) was 100% for top 10, or 75% or more for top 20. The precision (precision value) and the recall value are given in the following expression (1).

Numerical Expression 1

I. Recall

A measure of the ability of a system to present all relevant items.

$$recall = \frac{number of relevant items retrieved}{number of relevant items in collection} \qquad ( 1 )$$

II. Precision

A measure of the ability of a system to present only relevant items.

$$precision = \frac{number of relevant items retrieved}{total number of items retrieved} \qquad ( Example 2 )$$

(1) Comparative Examination Between RAV Method and RP Method

For the same query, the recall-precision curve was computed by the RAV method of the invention and the RP method, using a means as defined in Text Research Collection Volume 5, April 1997, http://trec.nist.gov/. At this time, the dimension reduction matrix R in the RP method was given in the following
Expression (2).

$${r}_{i , j} = \sqrt{3} \{ \begin{matrix}+ 1 & with probability 1 / 6 \\ 0 & with probability 2 / 3 \\ - 1 & with probability 1 / 6\end{matrix} \qquad Numerical expression 2$$

(2) Results

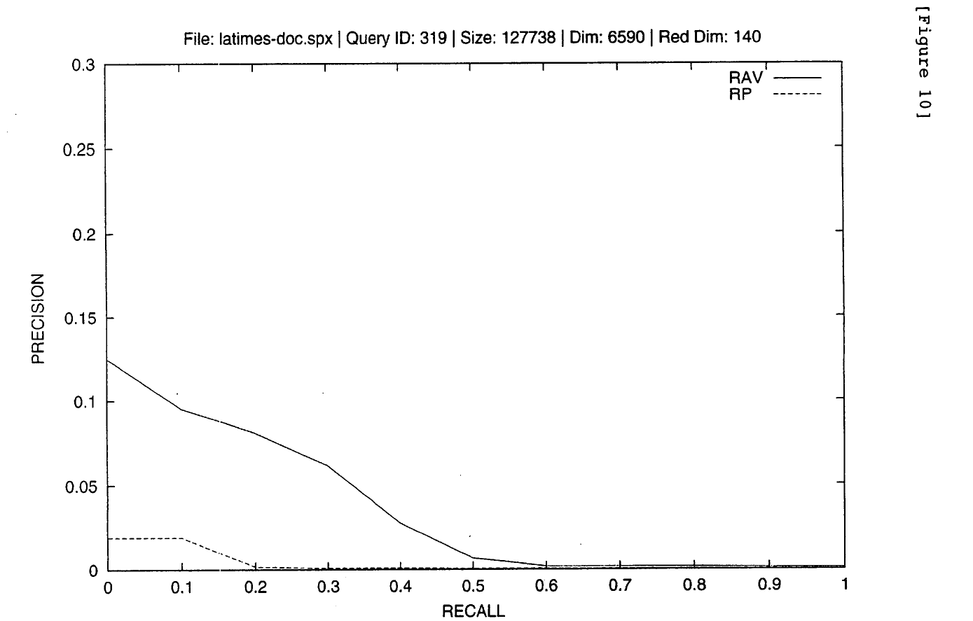

Typical results obtained by the RAV method and the RP method are shown in FIG. 10. As shown in FIG. 10, the RAV method of the invention has roughly a higher precision (precision value) than the RP method. Regarding the computation time, it was found that the RP method was much faster. However, with the RAV method of the invention, the computation was ended in 5 to 10 minutes, and the sufficiently high speed was attained. This is because the process for making the basis vectors orthogonal is included in the invention.

### Example 3

Computer Resource Consumption

Computation experiments were conducted under the same conditions, in which the memory consumption amounts in run time were compared. The following Table 2 shows the memory use amounts as measurement data for the methods.

TABLE 2

| | RAV | RP | COV | LSI |
|---|---|---|---|---|
| Memory use | about 100 MB | about 128 MB | about 800 | about 512 |
| amount | or less | or less | MB | MB |

As shown in Table 2, the method of the invention does not perform a large scale singular value or eignevalue decomposition, whereby the storage space in the computer apparatus is greatly decreased. Also, since the required amount of storage space in run time was smaller than the RP method, the excellent results were obtained.

### Example 4

Minor Cluster Detection Ability

(1) Experiment Contents

Experiments for comparing the RAV method of the invention,and the RP method, from the standpoint of detecting the minor cluster, were conducted using the same database and under the same conditions as in example 2. The dimension reduction process involved 300 dimensions, the retrieval query used query1=<Michael Jordan, basketball> and query2=<McEnroe, tennis>, which were confirmed to be included in the minor cluster, and a comparison was made in the existence percentage of retrieval queries query1 and query2 in the upper level documents between the RAV method and the RP method.

(2) Experiment Results

The obtained experiment results are shown in Table 3 as below.

TABLE 3

| | RAV | RP |
|---|---|---|
| query1 | 95% | 25% |
| query2 | 85% | 53% |

As seen from the Table 3, the RAV method has more excellent detection ability for the minor cluster and higher precision than the RP method.

As described above, with this invention, it is possible to prevent wasteful consumption of the computer resources at high efficiency, and acquire the information indicting a detection precision stable from the major cluster to the minor cluster.

The present invention can be realized in hardware, software, or a combination of hardware and software. It may be implemented as a method having steps to implement one or more functions of the invention, and/or it may be implemented as an apparatus having components and/or means to implement one or more steps of a method of the invention described above and/or known to those skilled in the art. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or after reproduction in a different material form.

Thus the invention includes an article of manufacture which comprises a computer usable medium having computer readable program code means embodied therein for causing one or more functions described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in) the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1) A dimension reduction method for reducing the dimension of a numerical matrix with a computer to provide information, the method comprising:
a step of generating the shuffle information by selecting randomly a data vector stored in a database and storing said shuffle information in a memory; and
a step of reducing the dimension of said numerical matrix by the basis vectors that are made orthogonal using said shuffle information.

2) The dimension reduction method according to claim 1, wherein the step of generating said shuffle information comprises a step of storing an identification value of said data vector selected randomly in a memory in the selected order and a step of generating a shuffle vector, and the step of reducing said dimension comprises a step of reading the numerical elements of said data vector specified by said shuffle vector from said database, and calculating an average value for every allocated chunk to generate the non-normalized basis vectors that are stored in a memory, a step of making said non-normalized basis vectors orthogonal to generate the normalized basis vectors that are stored as a random average matrix in a memory, and a step of multiplying said random average matrix by said data vector to generate a dimension reduction matrix with reduced dimension or the index data for dimension reduction that is stored in a storing part.

3) The dimension reduction method according to claim 1, wherein the number of said chunks corresponds to the number of basis vectors.

4) The dimension reduction method according to claim 2, wherein the step of calculating said average value comprises a step of averaging the elements of said data vector for every floor (M/k) with the number of data vectors (M) and the number of basis vectors (k).

5) A computer executable program for performing a dimension reduction method for reducing the dimension of a numerical matrix with a computer to provide a dimension reduction matrix or the index data for dimension reduction, said method comprising:
a step of generating the shuffle information by selecting randomly a data vector stored in a database and storing said shuffle information in a memory; and
a step of reducing the dimension of said numerical matrix by the basis vectors that are made orthogonal using said shuffle information.

6) The computer executable program according to claim 5, wherein the step of generating said shuffle information comprises a step of storing an identification value of said data vector selected randomly in a memory in the selected order, and the step of reducing said dimension comprises a step of reading the numerical elements of said data vector specified by said shuffle vector from said database, and calculating an average value for every allocated chunk to generate the non-normalized basis vectors that are stored in a memory, a step of making said non-normalized basis vectors orthogonal to generate the normalized basis vectors that are stored as a random average matrix in a memory, and a step of multiplying said random average matrix by said data vector to generate a dimension reduction matrix with reduced dimension or the index data for dimension reduction that is stored in a storing part.

7) The computer executable program according to claim 6, wherein the number of said chunks corresponds to the number of basis vectors.

8) The computer executable program according to claim 6, wherein the step of calculating said average value comprises a step of averaging the elements of said data vector for every floor (M/k) with the number of data vectors (M) and the number of basis vectors (k).

9) A dimension reduction device for reducing the dimension of a numerical matrix with a computer to provide a dimension reduction matrix or the index data for dimension reduction, said device comprising:
a processing part for generating the shuffle information by selecting randomly a data vector stored in a database to store said shuffle information in a memory; and
a processing part for generating a random average matrix with the basis vectors that are made orthogonal using said shuffle information, and generating a dimension reduction matrix or the index data for dimension reduction using said random average matrix to store said dimension reduction matrix or said index data.

10) The dimension reduction device according to claim 9, wherein said processing parts comprise a shuffle vector generating part for generating the shuffle information as a shuffle vector by storing an identification value of said data vector selected randomly in a memory in the selected order and a non-normalized basis vector generating part for generating the non-normalized basis vectors that are stored in a memory by reading the numerical elements of said data vector specified by said shuffle vector from said database, and calculating an average value for every allocated chunk.

11) The dimension reduction device according to claim 10, wherein said processing parts comprise a random average matrix generating part for generating a random average matrix with the normalized basis vectors obtained by making the non-normalized basis vectors orthogonal, and a dimension reduction data storing part for generating a dimension reduction matrix with reduced dimension or the index data for dimension reduction that is stored in a storing part by reading said random average matrix, and multiplying said random average matrix by said data vector.

12) A retrieval engine for enabling a computer to provide information, comprising:
a processing part for generating the shuffle information by selecting randomly a data vector stored in a database to store said shuffle information in a memory;
a processing part for generating a random average matrix with the basis vectors that are made orthogonal using said shuffle information, and generating a dimension reduction matrix using said random average matrix to store said dimension reduction matrix;
a query vector storing part for generating and storing a query vector;
an inner product calculating part for calculating an inner product between said dimension reduction matrix and said query vector; and
a retrieval result storing part for storing a score of said calculated inner product.

13) The retrieval engine according to claim 12, wherein said
processing parts comprise a shuffle vector generating part for generating the shuffle information as a shuffle vector by storing an identification value of said data vector selected randomly in a memory in the selected order and a non-normalized basis vector generating part for generating the non-normalized basis vectors that are stored in a memory by reading the numerical elements of said data vector specified by said shuffle vector from said database, and calculating an average value for every allocated chunk.

14) The retrieval engine according to claim 13, wherein said processing parts comprise a random average matrix generating part for generating a random average matrix with the normalized basis vectors obtained by making the non-normalized basis vectors orthogonal, and a dimension reduction data storing part for generating a dimension reduction matrix with reduced dimension or the index data for dimension reduction that is stored in a storing part by reading said random average matrix, and multiplying said random average matrix by said data vector.

15) The retrieval engine according to claim 12, wherein said data vector comprises a number vector in which a document is digitized using a keyword.

16) An article of manufacture comprising a computer usable medium having computer readable program code means embodied therein for causing dimension reduction, the computer readable program code means in said article of manufacture comprising computer readable program code means for causing a computer to effect the steps of claim 1.

17) A program storage device readable by machine, tangibly embodying a program of instructions executable by the machine to perform method steps for dimension reduction, said method steps comprising the steps of claim 1.

18) A computer program product comprising a computer usable medium having computer readable program code means embodied therein for causing functions of a dimension reduction device for reducing the dimension of a numerical matrix with a computer to provide a dimension reduction matrix or the index data for dimension reduction, the computer readable program code means in said computer program product comprising computer readable program code means for causing a computer to effect the functions of:
a processing part for generating the shuffle information by selecting randomly a data vector stored in a database to store said shuffle information in a memory; and
a processing part for generating a random average matrix with the basis vectors that are made orthogonal using said shuffle information, and generating a dimension reduction matrix or the index data for dimension reduction using said random average matrix to store said dimension reduction matrix or said index data.

19) A computer program product comprising a computer usable medium having computer readable program code means embodied therein for causing functions of a retrieval engine for enabling a computer to provide information, the computer readable program code means in said computer program product comprising computer readable program code means for causing a computer to effect the functions of:
a processing part for generating the shuffle information by selecting randomly a data vector stored in a database to store said shuffle information in a memory;
a processing part for generating a random average matrix with the basis vectors that are made orthogonal using said shuffle information, and generating a dimension reduction matrix using said random average matrix to store said dimension reduction matrix;
a query vector storing part for generating and storing a query vector;
an inner product calculating part for calculating an inner product between said dimension reduction matrix and said query vector; and
a retrieval result storing part for storing a score of said. calculated inner product.
